(19) United States
(12) Patent Application Publication
(10) Pub. No.: US 2011/0243421 A1
(43) Pub. Date: Oct. 6, 2011

(54) CHECK PROCESSING APPARATUS

(75) Inventor: Norishige INOUE, Hyogo (JP)

(73) Assignee: GLORY LTD.

(21) Appl. No.: 12/751,287

(22) Filed: Mar. 31, 2010

(51) Int. Cl. G06K 9/00

(52) U.S. Cl. 382/138

(57) ABSTRACT

A check processing apparatus including a check inlet unit, a transport unit, a reading unit, a storing unit, and a post-processing determining unit is provided. The check inlet unit receives input of a check. The transport unit transports the check input from the check inlet unit. The reading unit reads, from the check transported by the transport unit, check information containing a check amount. The storing unit stores therein the check. The post-processing unit determines, as post processing of a check from which the check information has been read by the reading unit, whether to store the check in the storing unit or to return the check, based on the check information.

### BACKGROUND OF THE INVENTION

1. Field of the Invention

The present invention relates to a check processing apparatus that processes a check.

2. Description of the Related Art

Conventionally, check processing apparatuses that read various types of information from checks and perform various types of processes by using the read information have been known. For example, Japanese Patent Application Laid-open No. 2006-155531 discloses a check processing apparatus that reads amount information written on a check and deposits money into a user's account in an amount corresponding to the read amount information.

### SUMMARY OF THE INVENTION

A check processing apparatus according to an aspect of the present invention is for processing a check, and includes a check inlet unit that receives the check; a transport unit that transports the check input from the check inlet unit; a reading unit that reads, from the check transported by the transport unit, check information containing a check amount; a storing unit that stores therein the check; and a post-processing determining unit that determines, as post processing of a check from which the check information has been read by the reading unit, whether to store the check to the storing unit or to return the check based on the check information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an overview of a check processing technique according to the present invention;

FIG. 2 is a block diagram of a configuration of a check processing apparatus according to the present embodiment;

FIG. 3 is a diagram illustrating external and internal structures of the check processing apparatus;

FIGS. 4A and 4B are diagrams representing an example of operations performed by a control unit when check information has normally been read;

FIGS. 5A and 5B are diagrams representing an example of operations performed by the control unit when an unreadable item is present in the check information;

FIG. 6 is a flowchart of a process procedure performed by the check processing apparatus according to the present embodiment; and

FIGS. 7A to 7C are diagrams for explaining situations in which checks are stacked in a sorted manner.

### DETAILED DESCRIPTION OF THE PREFERRED EMBODIMENTS

Exemplary embodiments of a check processing apparatus according to the present invention will be explained in detail below with reference to the accompanying drawings.

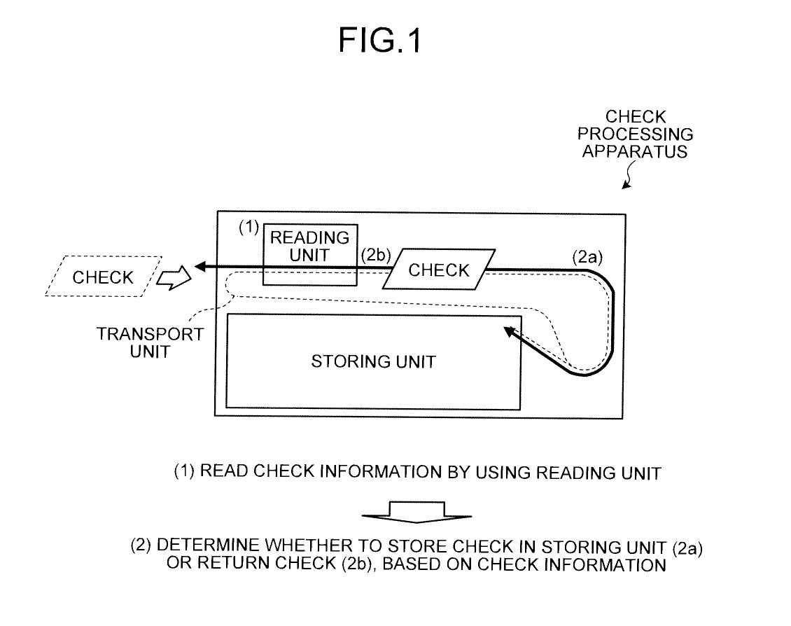

An overview of a check processing technique according the present invention is described below with reference to FIG. 1 before presenting detailed descriptions of the embodiments. FIG. 1 is a diagram illustrating the overview of the check processing technique according to the present invention.

As shown in the figure, with the check processing technique according to the present invention, whether a check is stored or returned as post processing of the check from which check information has been read can be determined based on the check information.

Specifically, as shown in the figure, in a check processing apparatus according to the present invention, a transport unit transports a received check to a reading unit, and the reading unit reads check information from the check (see (1) of the figure).

More specifically, the reading unit reads information written on the check, such as a check amount, an account number of a drawer, and a bank number, by using character recognition means such as OCR (Optical Character Recognition) and MICR (Magnetic ink Character Recognition). The reading unit also reads an image of a whole or a part of the check (hereinafter, referred to as “a check image”) as the check information, in addition to the information written on the check.

Subsequently, in the check processing apparatus, whether to store the check in a storing unit or to return the check is determined based on the check information read by the reading unit (see (2) of the figure).

For example, the check processing apparatus stores the check in the storing unit when the check amount is equal to or larger than a predetermined amount (see (2a) of the figure), and returns the check to a customer when the check amount is smaller than the predetermined amount (see (2b) of the figure). This is because, when the check amount is large, it is preferable to perform an ex-post confirmation operation by using actual paper checks in view of the security of a transaction.

Furthermore, the check processing apparatus is equipped with a function of displaying a check image read by the reading unit on a predetermined display unit or dispensing the check from the inside of the apparatus to the outside of the apparatus so that when the reading unit cannot read a part of the check information, the unread item can be visually confirmed by store staff. In this case, when the store staff inputs a content of the unread item by using a predetermined operation interface, the check processing apparatus replenishes the information input by the store staff into the check information read by the reading unit. Therefore, it is possible to handle even a check containing an item that cannot be read by the reading unit.

When the check information is replenished with the information by the store staff, the check processing apparatus stores the check in the storing unit (see (2a) of the figure). This is because it is preferable to perform ex-post confirmation to confirm whether the information input by the store staff is correct or not in view of the security of the transaction. Consequently, it is possible to prevent a fraudulent activity in which a customer does not correct information maliciously even when the information input by the store staff is incorrect, or the store staff conspires with a customer to intentionally input incorrect information.

As described above, the check processing apparatus according to the present invention includes the storing unit for storing checks. Furthermore, the check processing apparatus determines whether to store a check in the storing unit or to return the check based on the check information. Therefore, it is possible to appropriately perform post processing of a check from which the check information has been read.

When returning a check to a customer, the check processing apparatus drives the transport unit in a direction opposite to a normal transport direction to dispense the check from the check inlet unit. Furthermore, when returning a check, the check processing apparatus returns the check after printing a notice indicating that the check has been used on the check to prevent the check from being reused.

When the check has passed through the reading unit, i.e., when reading of the check information by the reading unit has been completed, the check processing apparatus according to the present invention temporarily stops the transport unit to hold the check on the transport unit. In other words, every check from which check information has been read by the reading unit is stopped at a predetermined position on the transport unit until a content of the post processing is determined.

Subsequently, the check processing apparatus displays the chock information read by the reading unit onto a display unit while holding the check on the transport unit, and requests a customer to accept the check information. Then, when receiving from a operation unit a notice of acceptance containing a notice that the contents of the check information are accepted, the check processing apparatus resumes driving of the transport unit to transport the check to either the storing unit or the check inlet unit.

In this manner, the check is held on the transport unit by temporarily stopping the transport unit when the check has passed through the reading unit. Therefore, the check processing apparatus can be downsized and costs can be reduced compared with ones equipped with an additional mechanism for holding checks.

Furthermore, in the check processing apparatus, the storing unit may be comprises a plurality of separate stackers and checks may be stacked in a sorted manner based on the check information. For example, the check processing apparatus may sort checks for which ex-post confirmation is necessary and checks for which ex-post confirmation is not necessary from each other. Furthermore, the check processing apparatus may sort checks according to a check amount. y stacking checks in a sorted manner as described above, an operation of collecting checks can be simplified.

The storing unit may be a cassette-type storing unit detachable from the check processing apparatus. Furthermore, the storing unit may be able to not only store checks but also to output stored checks.

Described below are embodiments of the check processing apparatus to which the check processing technique described above with reference to FIG. 1 is applied. In the embodiments described below, an example is described in which the check processing apparatus according to the present invention is connected to a POS terminal installed in a store such as a convenience store and a supermarket.

In other words, in the embodiments described below, it is assumed that the check processing apparatus according to the present invention is used to pay for purchases of products by check and is installed at a payment counter of a store together with the POS terminal. The check processing apparatus according to the present invention may be connected to a cash dispenser such as a change dispenser, a cash depositing/dispensing apparatus, and the like, instead of being connected to a cash register such as the POS terminal. Furthermore, the check processing apparatus according to the present invention may he included in a money handling apparatus.

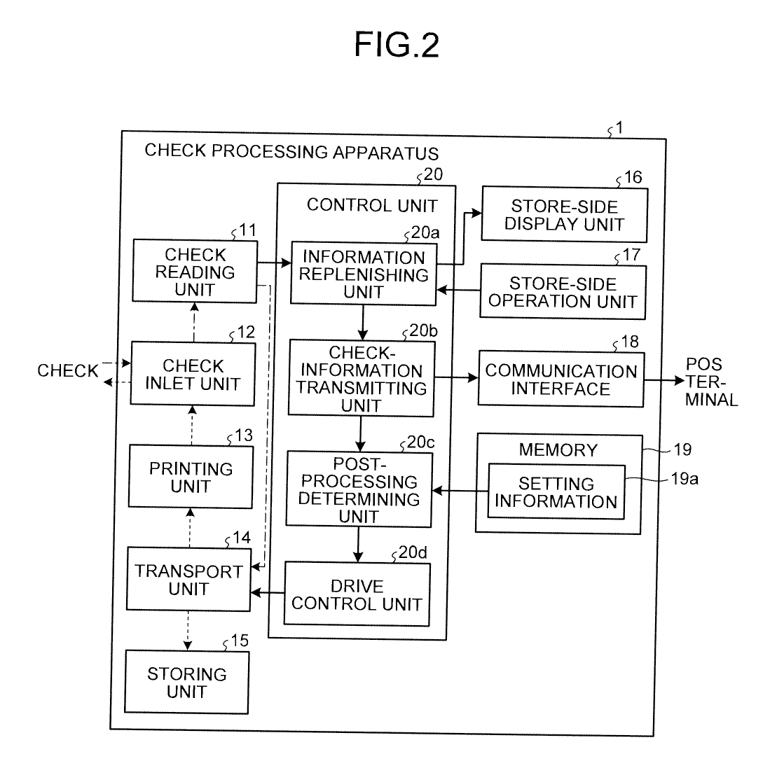

FIG. 2 is a block diagram of a configuration of a check processing apparatus according to a present embodiment. Furthermore, a dash-dot line in the figure indicates a flow of a check from when the check is input into the check processing apparatus to when check information is read, and a chain line in the figure indicates a flow of the check from when reading of the check information is completed to when the check is stored or returned.

As shown in the figure, a check processing apparatus 1 includes a check reading unit 11, a check inlet unit 12, a printing unit 13, a transport unit 14, a storing unit 15, a store-side display unit 16, a store-side operation unit 17, a communication interface 18, a memory 19, and a control unit 20. The memory 19 stores therein setting information 19a. The control unit 20 includes an information replenishing unit 20a, a check-information transmitting unit 20b, a post-processing determining unit 20c, and a drive control unit 20d.

The check reading unit 11 is a check reading device that is arranged on the transport unit 14, and reads check information from a check transported by the transport unit 14. More specifically, the check reading unit 11 reads, as the check information, an issue date of a check, a payment recipient, a check amount, drawer information, payee information, a check number, a bank number, and an account number of a drawer. The check number is an issuance number for identifying each check owned by the drawer, and the bank number is financial institution information for identifying a financial institution that has issued the check. The check reading unit 11 reads the above-mentioned check information by character recognition means such as OCR and MICR.

Moreover, the check reading unit 11 includes a scanner as an image reading device, and reads a check image as the check information in addition to the information written on the check. The check image read by the scanner may be an image of one side surface of the check or an image of both side surfaces of the check. Similarly, the check image read by the scanner may be an image of the whole check or an image of a part of the check.

The check reading unit 11 also performs a process of sending the read check information to the information replenishing unit 20a upon reading the check information from the check.

The check inlet unit 12 receives a check. The check inlet unit 12 may function as a dispensing unit that returns a check to a customer. A check to be input from the check inlet unit 12 may be input by a customer him/herself or store staff who has received the check from the customer.

The printing unit 13 is arranged on the transport unit 14 between the check reading unit 11 and the storing unit 15, and prints predetermined information on a check surface. For example, the printing unit 13 prints on a check a notice that the check has been used. The printing unit 13 may function as an endorser for printing transaction information and the like as endorsement of the check to be stored in the storing unit 15.

Furthermore, the printing unit 13 may be equipped with a function of printing on a check magnetic ink characters to be recognized by MICR. With this configuration, the check processing apparatus 1 is allowed to print a check amount on a check in magnetic ink characters.

In other words, when financial institutions process checks, a check amount written by hand or printed by machines is printed on a predetermined space on each check in magnetic ink characters, and then various processes are performed by reading, through MICR, the check amount printed in the magnetic ink characters. Therefore, when the printing unit 13 is equipped with the function of performing printing in the magnetic ink characters, the check processing apparatus 1 can perform, as a series of processes, a process reading a check amount written on a check and a process of printing the read check amount in the magnetic ink characters.

The printing unit 13 need not necessarily print the check amount in the magnetic ink characters, and may print the check amount in characters other than the magnetic ink characters. Furthermore, the printing unit 13 may print information other than the check amount, such as “check processing date”, “store information”, and “cashier information” that may be useful when troubles occur during the post processing.

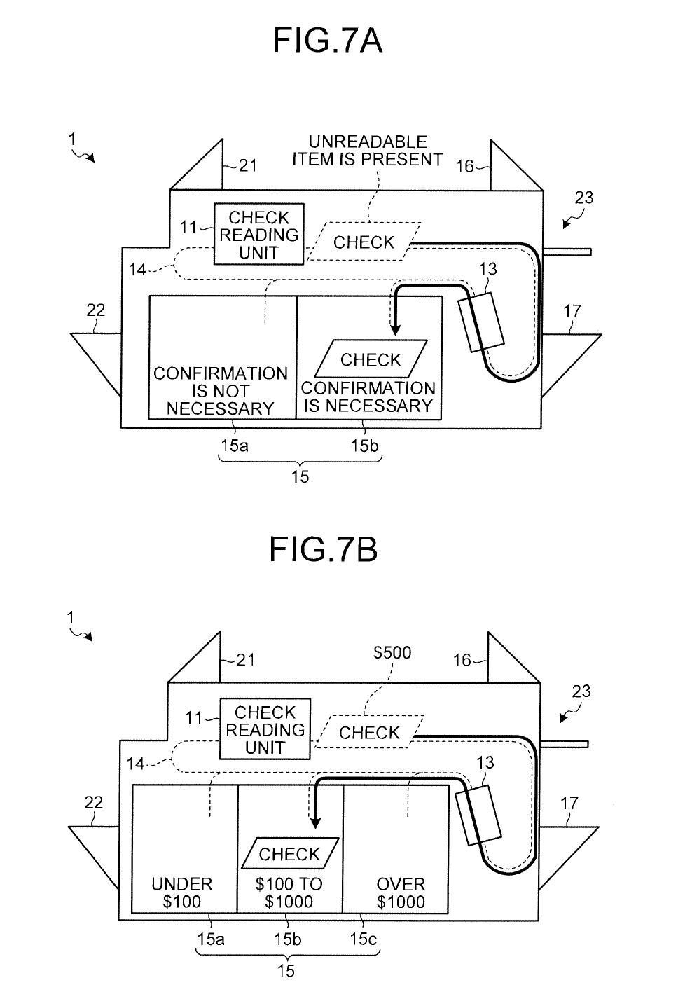

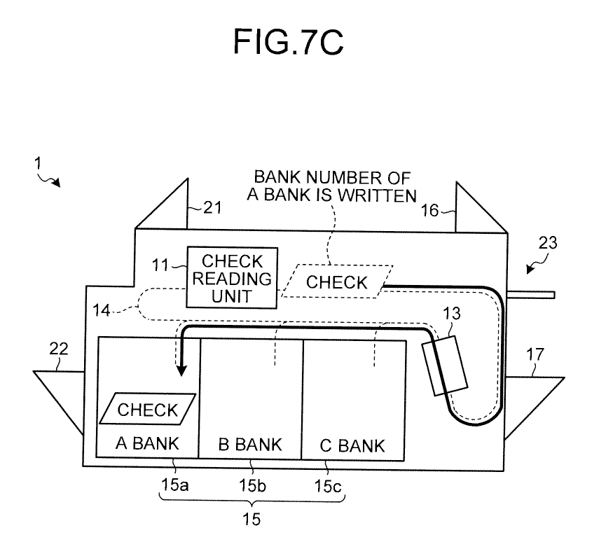

The transport unit 14 includes a belt conveyor for transporting checks one by one by holding the checks, a drive unit of the belt conveyor, rollers for driving the belt conveyor, and diverters arranged at each branch point of the transport path, and the like. The storing unit 15 is for storing a check from which check information has been read by the check reading unit 11. The storing unit 15 may comprises a plurality of storages, which will be described later with reference to FIGS. 7A to 7C.

The store-side display unit 16 is a display device for presenting various types of information to store staff of stores in which the check processing apparatus is installed. For example, when an item that has not been read by the check reading unit 11 (hereinafter, referred to as “unreadable item”) is present in items contained in the check information, a check image read by the check reading unit 11 is displayed on the store-side display unit 16. The store staff reads contents of the unreadable item by viewing the check image displayed on the store-side display unit 16, and manually inputs the read contents by using the store side operation unit 17.

The store-side operation unit 17 is a processing unit that receives various types of operations from the store staff. For example, the store-side operation unit 17 receives an operation of inputting contents of an unreadable item from the store staff, and sends the contents of the received input operation to the information replenishing unit 20a. Accordingly, the information replenishing unit 20a replenishes the check information with the information received from the store-side operation unit 17. The communication interface 18 is a communication device that transmits and receives communication data to and from the POS terminal.

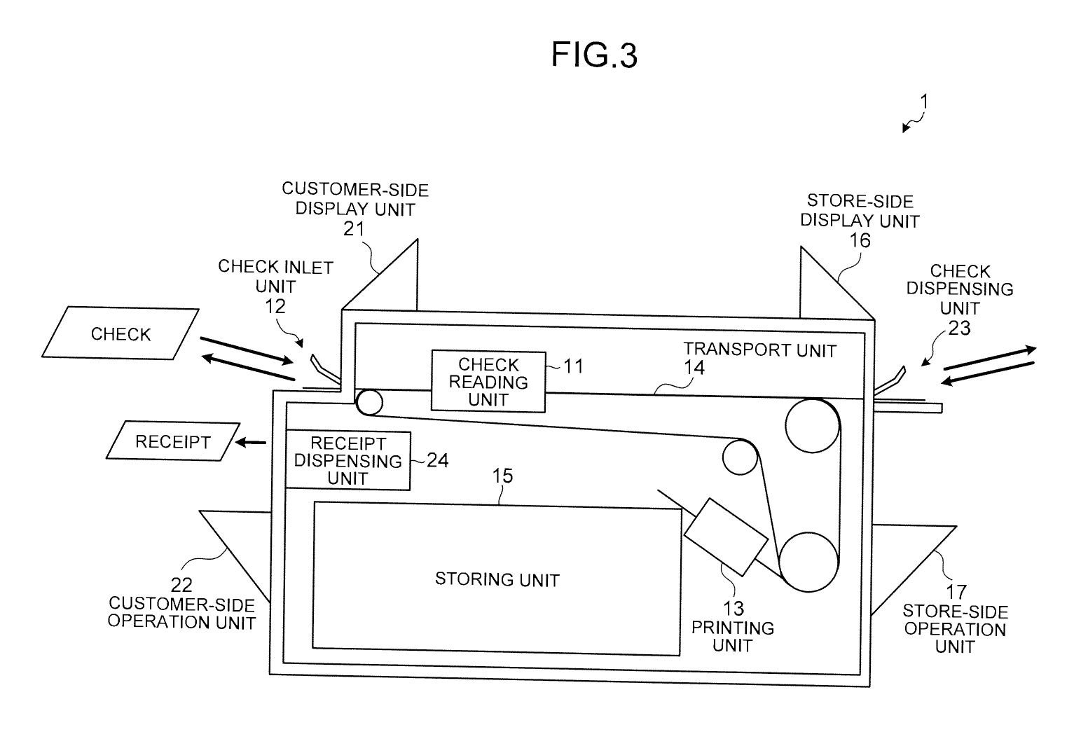

An external structure and an internal structure of the check processing apparatus 1 shown in FIG. 2 are described below with reference to FIG. 3. FIG. 3 is a diagram illustrating the external and internal structures of the check processing apparatus 1.

As shown in the figure, the check processing apparatus 1 comprises a customer-side display unit 21, the check unit 12, a customer-side operation unit 22, the store-side display unit 16, a check dispensing unit 23, and the store-side operation unit

The customer-side display unit 21 is a display device for presenting various types of information to customers. For example, when the check information has normally been read by the check reading unit 11, a confirmation screen containing the read check information, the check image, and the like is displayed on the customer-side display unit 21.

The customer-side operation unit 22 is a processing unit that receives various types of operations from customers. For example, the customer-side operation unit 22 includes an accept button. The accept button is a button to be pressed by customers when the customers accept contents of the check information. The customers press the accept button after confirming whether the contents of the check information are correct or not by viewing the confirmation screen displayed on the customer-side display unit 21.

Furthermore, the customers are allowed to request return of a check by using the customer-side operation unit 22. When receiving a check return request from the customers, the check processing apparatus 1 confirms whether a check amount is equal to or smaller than a predetermined amount or like. Then, when determining that there is no problem with return of the check, the check processing apparatus 1 returns the check.

The check dispensing unit 23 dispenses checks transported by the transport unit 14 to the outside of the apparatus. The check dispensing unit 23 may function as an inlet unit for inputting checks.

The check inlet unit 12, the customer-side display unit 21, and the customer-side operation unit 22 are arranged on a surface of the check processing apparatus 1; and the store-side display unit 16, the store-side operation unit 17, and the check dispensing unit 23 are arranged on a side opposing to the side where the customer-side display unit 21 and the customer-side operation unit 22 are arranged. Therefore, when the check processing apparatus 1 is to be installed at a payment counter of stores, the check processing apparatus 1 can be installed such that the check inlet unit 12, the customer-side display unit 21, and the customer-side operation unit 22 to be used by customers face a customer side, and the store-side display unit 16, the store-side operation unit 17, and the check dispensing unit 23 to be used by store staff face a store-staff side.

It is assumed that the store-side display unit 16 and the customer-side display unit 21 are arranged on opposing side surfaces of the check processing apparatus 1; however, it is not limited thereto. The store-side display unit 16 and the customer-side display unit 21 may be arranged on adjacent surfaces of the check processing apparatus 1. The same can be applied to the store-side operation unit 17 and the customer-side operation unit 22.

Furthermore, the store-side display unit 16, the customer-side display unit 21, the store-side operation unit 17, and the customer-side operation unit 22 are not necessarily arranged on the check processing apparatus 1, and may be provided separately. For example, a display unit and an operation unit arranged on the FOS terminal may be used as alternatives to the store-side display unit 16 and the store-side operation unit 17, respectively. Moreover, the check processing apparatus 1 may be equipped with a single display unit and a single operation unit.

On the other hand, the check processing apparatus 1 includes the check reading unit 11, the printing unit 13, the transport unit 14, the storing unit 15, and a receipt dispensing unit 24. The receipt dispensing unit 24 issues a receipt with a written transaction result and the like when a transaction by check is normally completed. On the receipt, information for identifying a transaction is written, such as a transaction date, a check number, and a check amount. Furthermore, on the receipt, store information for identifying a store in which the check processing apparatus 1 is installed, staff information identifying staff who has performed a process, a check image, and the like may be printed.

The check processing apparatus 1 need not necessarily include the receipt dispensing unit 24. For example, the check processing apparatus 1 may output a receipt from an external apparatus, such as the POS terminal or a printer, connected to the check processing apparatus 1. Furthermore, the check processing apparatus 1 and the external apparatus may add a check-processing transaction result to a normal receipt that is issued when a customer purchases a product.

As shown in the figure, the check reading unit 11 and the printing unit 13 are arranged on the transport unit 14. A check input from the check inlet unit 12 or the check dispensing unit 23 is transported by the transport unit 14 so that the check passes through the check reading unit 11 and the printing unit 13 and is stored in the storing unit 15.

It is possible to dispense the check from the check dispensing unit 23 or the check inlet unit 12 by driving the transport unit 14 reversely without storing the check in the storing unit 15.

Referring back to FIG. 2, the memory 19 is explained. The memory 19 is a memory device such as a nonvolatile memory and a hard disk drive, and stores therein the setting information 19a. The setting information 19a is information for def contents of operations of the post-processing determining unit 20c to be described later. The setting information 19a contains a plurality of patterns of the contents of the operations. The store staff is allowed to select any contents of the operations to change the operations of the post-processing determining unit 20c.

The control unit 20 transmits the check information to the POS terminal, and determines post processing to be performed on a check from which the check information has been read, based on the check information. Furthermore, the control unit 20 drives the transport unit 14 according to the determined contents. More specifically, the control unit 20 includes the information replenishing unit 20a, the check-information transmitting unit 20b, the post-processing determining unit 20c, and the drive control unit 20d.

The control unit 20 is an integrated circuit such as an ASIC (Application Specific Integrated Circuit) or an FPGA (Field Programmable Gate Array), or an electronic circuit such as a CPU (Central Processing Unit) and an MPU (Micro Processing Unit).

The information replenishing unit 20a is a processing at replenishes, when the check information received the check reading unit 11 contains an unreadable item, the check information with information input through the store-side operation unit 17 as information corresponding to the unreadable item.

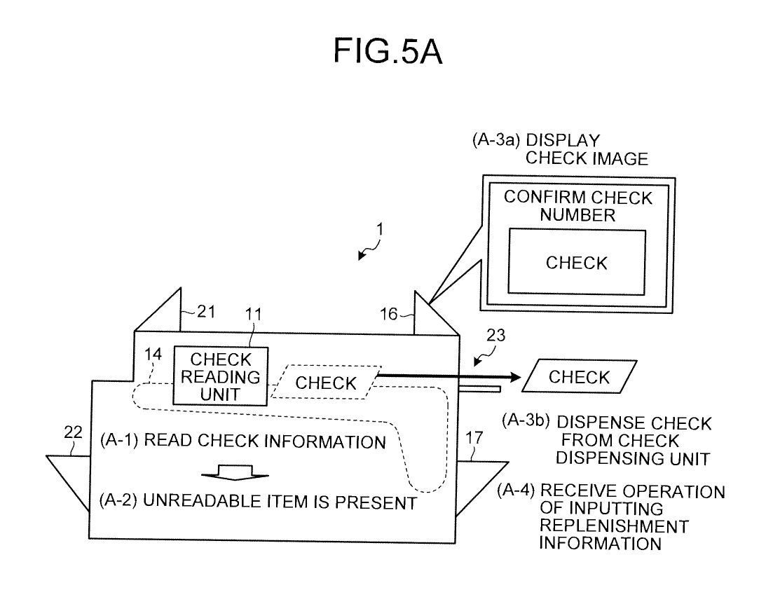

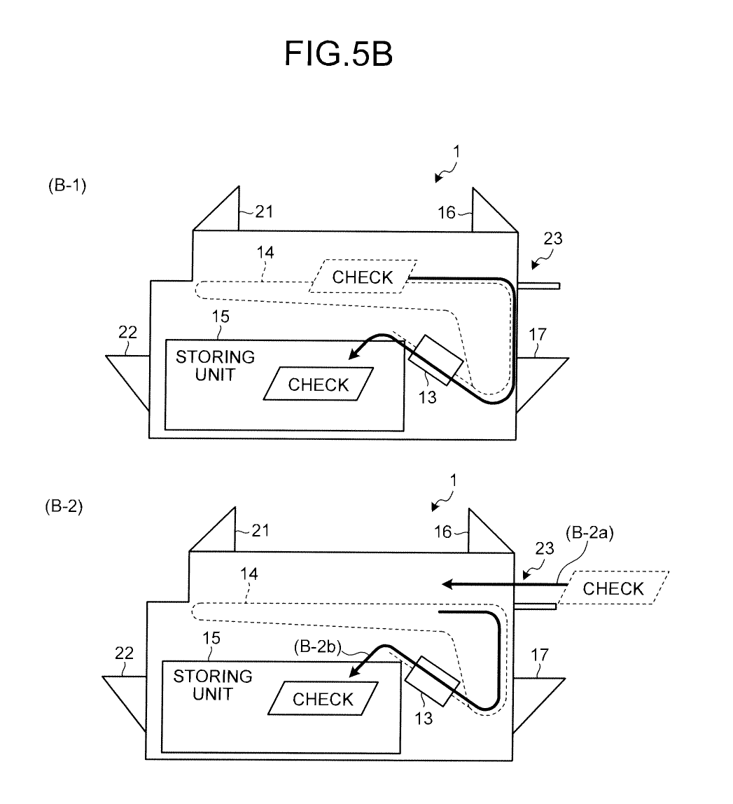

More specifically, when receiving the check information from the check reading unit 11, the information replenishing unit 20a confirms whether an unreadable item is contained in the received check information. Then, when the unreadable item is contained, the information replenishing unit 20a requests store staff to manually input information corresponding to the unreadable item, and replenishes the check information with the input information as the information corresponding to the unreadable item (hereinafter, referred to as “replenishment information”). An example of detailed operations performed by the information replenishing unit 20a will be described later with reference to FIGS. 5A and 5B.

When the unreadable item is not contained in the check information, i.e., when the check reading unit 11 has normally read the check information, the information replenishing unit 20a directly sends the check information received from the check reading unit 11 to the check-information transmitting unit 20b. On the other hand, when the unreadable item is contained in the check information, the information replenishing unit 20a sends, as new check information, the check information received from the check reading unit 11 and replenished with the replenishment information to the information replenishing unit 20a. In this case, when replenishing the check information, the information replenishing unit 20a sends a notice indicating that the check information is replenished to the check-information transmitting unit 20b together with the check information.

In this manner, even when an item that has not been read from the check by the check processing apparatus 1 is present, the information replenishing unit 20a acquires information corresponding to the unreadable item from the store staff via the store-side operation unit 17. Therefore, it is possible to send the check information replenished with all items to the check-information transmitting unit 20b.

The check-information transmitting unit 20b transmits the check information received from the information replenishing unit 20a to the POS terminal via the communication interface 18. When transmitting the check information to the POS terminal, the check-information transmitting unit 20b also performs a process of sending the check information to the post-processing determining unit 20c. When receiving a notice indicating that the check information is replenished from the information replenishing unit 20a, the check-information transmitting unit 20b also sends this notice to the post-processing determining unit 20c.

When acquiring the check information from the check-information transmitting unit 20b, the POS terminal performs a payment process for a product by using the acquired check information. When the check processing apparatus 1 is connected to a cash dispenser and a cash depositing/dispensing apparatus, the cash dispenser and the cash depositing/dispensing apparatus may cash the check by using the check information acquired from the check processing apparatus 1. Furthermore, the cash dispenser and the cash depositing/dispensing apparatus may update an account, e.g., dispense cash from a related account, by using the check information acquired from the check-information transmitting unit 20b.

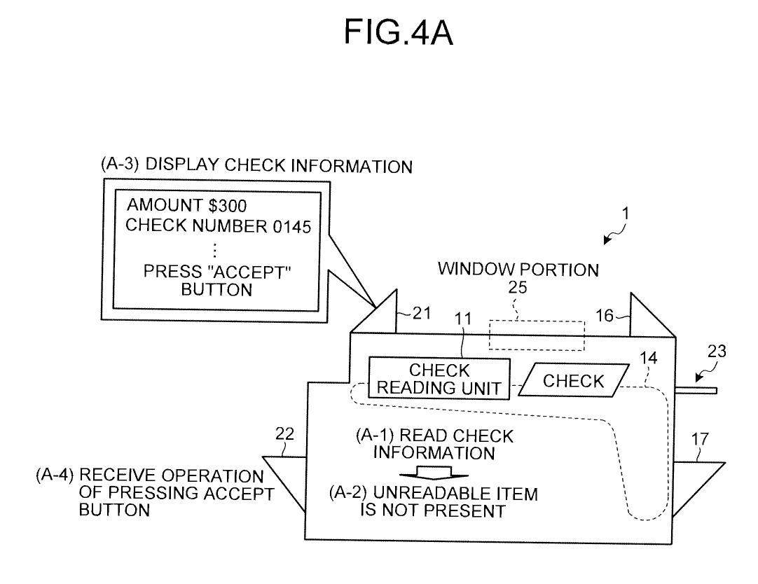

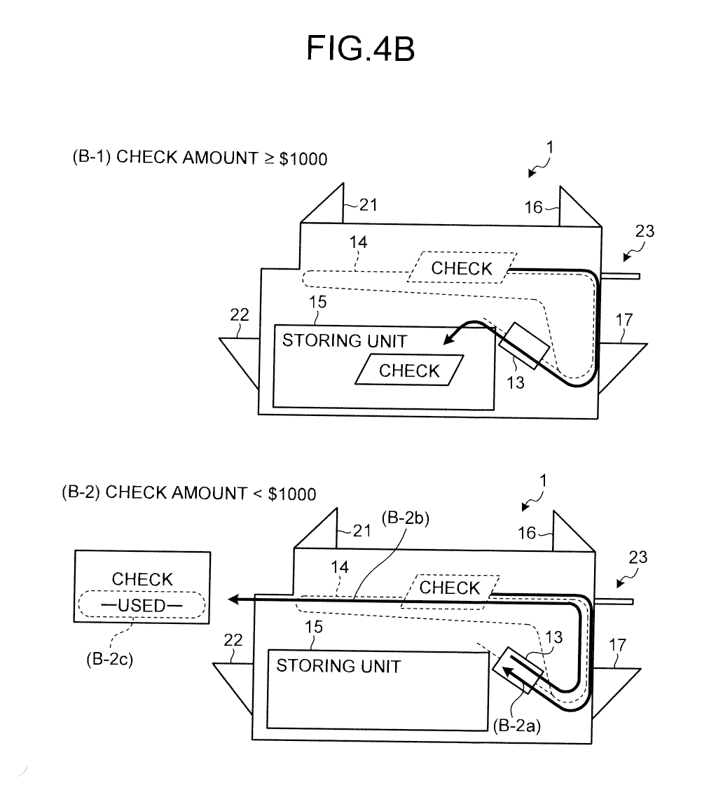

The post-processing determining unit 20c is a processing unit that determines whether to store the check in the storing unit 15 or to return the check based on the received check information upon receiving the check information from the check-information transmitting unit 20b. When determining a content of the post processing, the post-processing determining unit 20c instructs the drive control unit 20d to drive the transport unit 14. An example of detailed operations performed by the post-processing determining unit 20c will be described later with reference to FIGS. 4A, 45, 5A, and 5B.

The drive control unit 20d is a processing unit that controls driving of the transport unit 14. More specifically, the drive control unit 20d drives the transport unit 14 in a normal transport direction or in a direction opposite to the normal transport direction according to a drive instruction received from the post-processing determining unit 20c.

An example of operations performed by the control unit 20 is described below with reference to FIGS. 4A, 4B, 5A, and 55. An example of operations performed by the control unit 20 when the check processing apparatus 1 has normally read the check information is described first with reference to FIGS. 4A and 4B. FIGS. 4A and 4B are diagrams representing an example of operations performed by the control unit when the check information has normally been read.

As shown in FIG. 4A, in the check processing apparatus 1, when the check inlet unit 12 receives input of a check, the transport unit 14 transports the received check to the check reading unit 11, and the check reading unit 11 reads the check information, such as a check amount and an account number, from the transported check (see (A-1) of FIG. 4A). it is assumed here that the check information read by the check reading unit 11 does not contain an unreadable item (see (A-2) of FIG. 4A). In other words, it is assumed that the check reading unit 11 has normally read the check information from the check.

In this case, the post-processing determining unit 20c displays a confirmation screen containing the contents of the check information read by the check reading unit 11 and a request for acceptance from a customer on the customer-side display unit 21 (see (A-3) of FIG. 4A). Although not shown in (A-3) of FIG. 4A, the confirmation screen displayed on the customer-side display unit 21 may contain a check image. Also, the confirmation screen may be displayed on the store-side display unit 16.

When the check has passed through the check reading unit 11, i.e., when the check reading unit 11 has normally read the check information from the check, the post-processing determining unit 20c instructs the drive control unit 20d to temporarily stop the transport unit 14. Then, the drive control unit 20d that has received the instruction temporarily stops the transport unit 14. Accordingly, the check is temporarily held on the transport unit 14 until the acceptance from a customer is obtained. More specifically, the check is held on the transport path near the check reading unit 11.

As shown in FIG. 4A, the check processing apparatus 1 includes a window portion 25 that is arranged at an upper portion of a position where the check is stopped and that allows the inside of the apparatus to be viewed.

On the other hand, the customer views the confirmation screen displayed on the customer-side display unit 21 and checks the contents of the check information read by the check reading unit 11. Then, when receiving an operation of pressing the accept button from the customer (see (A-4) of FIG. 4A), the customer-side operation unit 22 transmits to the post-processing determining unit 20c a notice of acceptance containing a notice indicating that the contents of the check information is accepted.

Subsequently, when receiving the notice of acceptance from the customer-side operation unit 22, as shown in FIG. 4B, the post-processing determining unit 20c determines whether to store the check in the storing unit 15 or to return the check depending on a check amount contained in the check information.

More specifically, when the check amount contained in the check information is equal to or larger than a predetermined amount (in this example, $1000), the post-processing determining unit 20c determines to store the check in the storing unit 15 (see (B-1) of FIG. 4B). This is because when the check amount is large, it is preferable to perform an ex-post confirmation operation by using actual paper checks in view of the security of the transaction.

When determining to store the check, the post-processing determining unit 20c instructs the drive control unit 20d to resume the driving of the transport unit 14. More specifically, the post-processing determining unit 20c instructs the drive control unit 20d to drive the transport unit 14 in a normal transport direction (i.e., a direction along which the check is transported from the check inlet unit 12 to the check reading unit 11) so as to transport the check to the storing unit 15. Then, the drive control unit 20d that has received the instruction drives the transport unit 14 in the normal direction, so that the check is transported to and stored in the storing unit 15.

As described above, when the check amount read by the check reading unit 11 is equal to or larger than the predetermined amount, the check is determined to be stored in the storing unit 15. Therefore, a transaction by a check can be performed safely.

Furthermore, the post-processing determining unit 20c displays the check information read by the check reading unit 11 on the customer-side display unit 21, and when receiving a notice of acceptance containing the notice indicating that the contents of the check information are accepted from customer-side operation unit 22, the post-processing determining unit 20c determines the post processing of the check based on the check information.

Therefore, even when the check reading unit 11 has read the check information with error contents, it is possible to prevent a transaction from being performed with the check information containing the error contents. When the contents of the check information is determined to be incorrect according to the confirmation screen displayed on the customer-side display unit 21, it is possible to allow the store staff to correct the information by using the store-side operation unit 17. It is also possible to instruct the drive control unit 20d to drive the transport unit 14 in an opposite direction to return the check out of the check inlet unit 12.

Furthermore, when the check has passed through the check reading unit 11, the drive control unit 20d is instructed to temporarily stop the transport unit 14, and, when the notice of acceptance is received from the customer-side operation unit 22, the drive control unit 20d is instructed to resume the driving of the transport unit 14. In other words, the check is held on the transport unit 14 until the acceptance from the customer is obtained. Therefore, the check processing apparatus 1 can be downsized compared with ones equipped with an additional mechanism for holding checks.

When check is stored in the storing unit 15, it is possible to endorse the check by using the printing unit 13 as an endorser.

On the other hand, when the check amount contained in the check information is smaller than the predetermined amount this example, $1000), the post-processing determining unit 20c determines to return the check (see (B-2) of FIG. 4B).

Furthermore, when determining to return the check, the post-processing determining unit 20c instructs the drive control unit 20d to resume the driving of the transport unit 14. More specifically, the post-processing determining unit 20c instructs the drive control unit 20d to drive the transport unit 14 in the normal transport direction so as to transport the check to the printing unit 13. Then, the drive control unit 20d that has received the instruction drives the transport unit 14 in the normal transport direction, so that the check is transported to the printing unit 13 (see (B-2a) of FIG. 4B).

Subsequently, the post-processing determining unit 20c instructs the printing unit 13 to print a notice indicating that the check has been used on the check. Then, the printing unit 13 that has received the instruction prints descriptions such as “used” on the check. The printing unit 13 may print a check amount in magnetic ink characters or other characters instead of printing the notice indicating that the check has been used. Furthermore, the printing unit may print information such as a check processing date, store information, and cashier information.

Subsequently, the post-processing determining unit 20c instructs the drive control unit 20d to drive the transport unit 14 in a direction opposite to the normal transport direction so as to transport the check to the check inlet unit 12. Then, the drive control unit 20d that has received the instruction drives the transport unit 14 in the opposite direction, so that the check is transported to the check inlet unit 12 (see (B-2b) of FIG. 4B). Consequently, the check is returned from the check inlet unit 12. The check returned from the check inlet unit 12 is printed with characters such as “used” as illustrated in (B-2c) of FIG. 4B.

As described above, in the check processing apparatus 1, when the check is returned to the customer, the transport unit 14 is driven in a direction opposite to the normal transport direction to return the check from the check inlet unit 12 to the customer. Furthermore, in the check processing apparatus 1, when the check is returned, a notice indicating that the check has been used is printed on the check surface to prevent the check from being reused. The check may be returned from the check dispensing unit 23 to the cashier.

Next, an example of operations performed by the control unit 20 when an unreadable item is present in the check information is described below with reference to FIGS. 5A and 5B. FIGS. 5A and 5B are diagrams representing an example of operations performed by the control unit 20 when an unreadable item is contained in the check information. More specifically, FIG. 5A illustrates an example of operations performed by the information replenishing unit 20a; and FIG. 5B illustrates an example of operations performed by the post-processing determining unit 20c and the drive control unit 20d.

As shown in FIG. 5A, in the check processing apparatus 1, the check reading unit 11 reads the check information from the check transported by the transport unit 14 (see (A-1) of FIG. 5A). At this time, it is assumed that the check information read by the check reading unit 11 contains an unreadable item (see (A-2) of FIG. 5A).

In this case, the information replenishing unit 20a displays a check image on the store-side display unit 16 (see (A-3a) of FIG. 5A) or instructs the drive control unit 20d to transport the check to the check dispensing unit 23 (see (A-3b) of FIG. 5A) so as to request the store staff to visually check the unreadable item. The store staff is allowed to arbitrarily set whether to display the check image on the store-side display unit 16 or to dispense the check from the check dispensing unit 23. Also the customer and the store staff can read the unreadable item on the actual paper check through a window portion 25 shown in FIG. 4A.

When the store staff can read the contents of the unreadable item by visually confirming the check image or actual paper check, the store staff inputs the read contents (replenishment information) by using the store-side operation unit 17. When receiving an operation of inputting the replenishment information (see (A-4) of FIG. 5A), the store-side operation unit 17 sends the received replenishment information to the information replenishing unit 20a. Then, when receiving the replenishment information from the store-side operation unit 17, the information replenishing unit 20a replenishes the check information with the received replenishment information, and sends the replenished check information as new check information to the check-information transmitting unit 20b.

On the other hand, as shown in FIG. 5B, when the check information is replenished with the replenishment Information as described above, the post-processing determining unit 20c determines to store the check in the storing unit 15 regardless of the check amount.

More specifically, when the check image is displayed on the store-side display unit 16 as shown in (A-3a) of FIG. 5A, the post-processing determining unit 20c instructs the drive control unit 20d to drive the transport unit 14 in the normal transport direction so as to transport the check to the storing unit 15. Then, the drive control unit 20d that has received the instruction drives the transport unit 14 in the normal transport direction, so the that check is transported to and stored in the storing unit 15 (see (B-1) of FIG. 52).

Furthermore, when the check is dispensed from the check dispensing unit 23 as shown in (A-3b) of FIG. 5A, the post-processing determining unit 20c instructs the drive control unit 20d to drive the transport unit 14 in the opposite direction so as to transport the check received from the check dispensing unit 23 to the inside of the apparatus. Then, the drive control unit 20d that has received the instruction drives the transport unit 14 in the opposite direction, so that the check is transported from the check dispensing unit 23 to the inside of the apparatus (see (B-2a) of FIG. 52). Then, similarly to the situation illustrated in (B-1) of FIG. 5B, the post-processing determining unit 20c stores the check in the storing unit 15 (see (2-2b) of FIG. 52).

As described above, when the unreadable item is present in the check information, the information replenishing unit 20a replenishes the check information with the replenishment intonation input through the store-side operation unit 17 as information corresponding to the unreadable item. Also, when the information replenishing unit 20a replenishes the check information with the information, the post-processing determining unit 20c determines to store the check in the storing unit 15.

Therefore, it is possible to perform ex-post confirmation to confirm whether the replenishment information input by the store staff is correct or not. It is also possible to prevent a fraudulent activity in which the customer does not correct the information maliciously even when the information input by the store staff is incorrect, or the store staff conspires with the customer to intentionally input incorrect information.

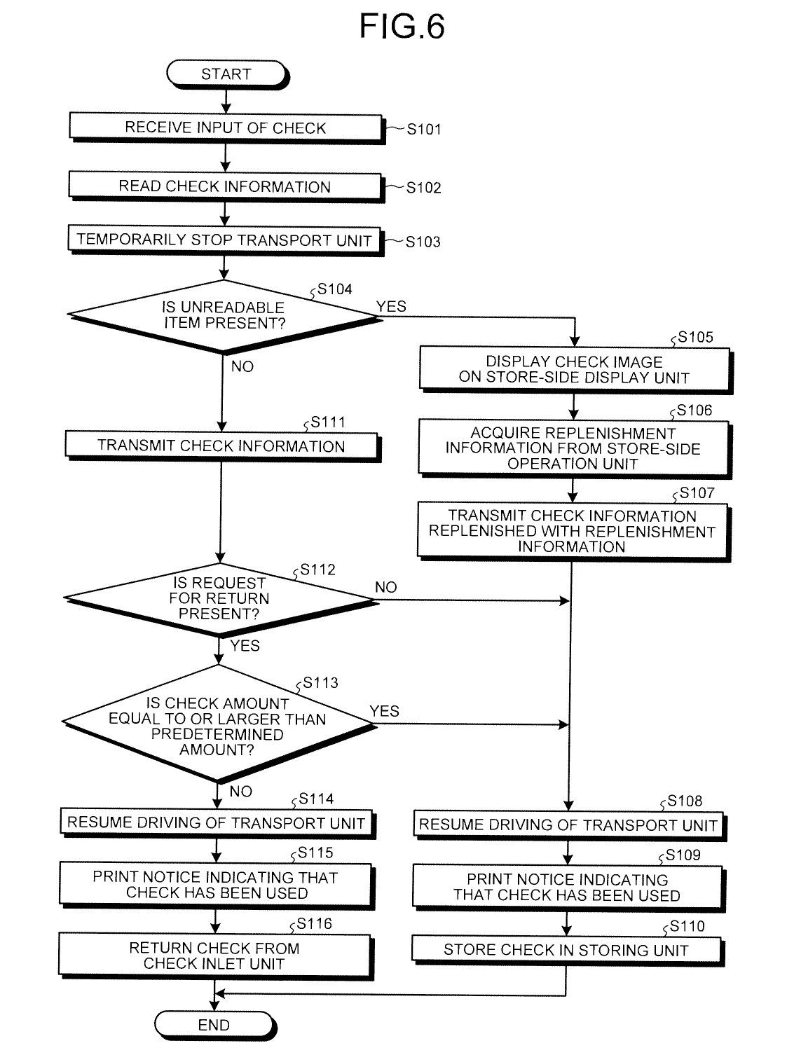

Next, an example of detailed operations performed by the check processing apparatus 1 according to the present embodiment is described below with reference to FIG. 6. FIG. 6 is a flowchart of a process procedure performed by the check processing apparatus 1 according to the present embodiment.

As shown in the figure, in the check processing apparatus 1, when the check inlet unit 12 receives the check (Step S101), the check reading unit 11 reads the check information from the check transported by the transport unit 14 (Step S102). Then, when reading of the check information is completed, the post-processing determining unit 20c instructs the drive control unit 20d to temporarily stop driving of the transport unit 14 (Step S103).

Subsequently, the information replenishing unit 20a determines whether an unreadable item is present in the check information read by the check reading unit 11 or not (Step S104). When determining that the unreadable item is present (YES at Step S104), the information replenishing unit 20a displays a check image on the store-side display unit 16 (Step S105). The information replenishing unit 20a may dispense the check from the check dispensing unit 23 at Step S105.

Subsequently, in the check processing apparatus 1, when the information replenishing unit 20a acquires the replenishment information from the store-side operation unit 17 (Step S106), the check-information transmitting unit 20b replenishes the check information with the replenishment information and then transmits the replenished check information to the POS terminal (Step S107).

When the check information is replenished with the replenishment information, the post-processing determining unit 20c instructs the drive control unit 20d to resume the driving of the transport unit 14 (Step 108). Accordingly, in the check processing apparatus 1, the drive control unit 20d drives the transport unit 14 to transport the check to the printing unit 13, and the printing unit 13 prints a notice indicating that the check has been used on the check (Step S109). Then, in the check processing apparatus 1, the drive control unit 20d drives the transport unit 14 to store the check in the storing unit 15 (Step S110), and the process ends.

On the other hand, when the unreadable item is not present in the check information read by the check reading unit 11 (NO at Step S104), the check-information transmitting unit 20b transmits the check information read y the check reading unit 11 to the POS terminal (Step S111).

Subsequently, the post-processing determining unit 20c determines whether a customer operates the customer-side operation unit 22 to request return of the check or not (Step S112). At this process, when the return of the check is not requested (NO at Step S112), the post-processing determining unit 20c performs the processes at Steps S108 and S110, and the process ends.

On the other hand, when determining that the return of the check is requested (YES at Step S112), i.e., when receiving from the customer-side operation unit 22 a notice indicating hat an operation of requesting return has been performed, the post-processing determining unit 20c determines whether the check amount contained in the check information is equal to or larger than a predetermined amount or not (Step S113). At this process, when determining that the check amount is equal to or larger than the predetermined amount (YES at Step S113), the post-processing determining unit 20c performs the processes at Steps S108 and S110, and the process ends.

On the other hand, when the check amount is smaller than the predetermined amount (NO at Step S113), the post-processing determining unit 20c instructs the drive control unit 20d to resume the driving of the transport unit 14 (Step S114). Accordingly, in the check processing apparatus 1, the drive control unit 20d drives the transport unit 14 to transport the check to the printing unit 13, and the printing unit 13 prints a notice indicating that the check has been used on the check (Step S115). Then, in the check processing apparatus 1, the drive control unit 20d drives the transport unit 14 to return the check from the check inlet unit 12 (Step S116), and the process ends.

As described above, in the present embodiment, the check inlet unit 12 receives the check; the transport unit 14 transports the check input from the check inlet unit 12; and the check reading unit 11 reads the check information containing the check amount, from the check transported by the transport unit 14. Furthermore, in the present embodiment, whether to store the check in the storing unit 15 or to return the check is determined based on the check information, as the post processing of the check from which the check information has been read by the check reading unit 11. Therefore, the post processing can be performed appropriately on the check from which the check information has been read.

In the embodiment described above, it is explained that the check processing apparatus 1 is installed at the payment counter of a store together with the POS terminal. However, the check processing apparatus 1 may be installed at a teller window of a bank and the like. In this case, when a bank in which the check processing apparatus 1 is installed can handle electronic checks, a post-transaction process can be performed only by exchanging check images. In other words, it is not necessary to deal with actual paper checks after transactions, so that checks may be returned without being stored.

On the other hand, when the bank in which the check processing apparatus 1 is installed cannot handle electronic checks and can only handle actual paper checks, checks may be stored in the storing unit 15. In this manner, it is possible to return checks when the bank in which the check processing apparatus 1 is installed can handle electronic checks, and store checks to perform post processing by using actual paper checks when the bank cannot handle electronic checks.

The store stuff and bank stuff are allowed to input the above-mentioned settings by using the store-side operation unit 17 and the customer-side operation unit 22. Furthermore, it is possible to store the above-mentioned settings as the setting information 19a in the memory 19 in advance so that a desired setting content can be selected by using the store-side operation unit 17 and the customer-side operation unit 22. Moreover, it is possible to download the setting information stored in an upper-layer terminal (not shown) to the check processing apparatus 1 via a network.

It has been explained in the embodiment described above that, when the check information is replenished with the replenishment information, the check is always stored in view of the security of transactions; however, it is not limited thereto. For example, even when the check information is replenished with the replenishment information, the check processing apparatus 1 may return the check to a customer if the check amount is equal to or smaller than a predetermined amount embodiment described above, it has been explained that transported checks are stored in the storing unit 15 without being sorted; however, it is not limited thereto. For example, it is possible to stack checks in a sorted manner according to various types of conditions.

This is described below with reference to FIGS. 7A to 7C. FIGS. 7A to 7C are diagrams for explaining situations in which checks are stacked in a sorted manner. More specifically, FIG. 7A illustrates a situation in which checks for which ex-post confirmation by the store staff is necessary and checks for which the ex-post confirmation is not necessary are sorted from each other; FIG. 7B illustrates a situation in which checks are sorted according to check amounts; and FIG. 7C illustrates a situation in which checks are sorted according to banks that have issued the checks.

As shown in FIG. 7A, the storing unit 15 includes a storing unit 15a for storing checks for which the ex-post confirmation by the store staff is not necessary, and a separate storing unit 15b for storing checks for which the ex-post confirmation by the store staff is necessary.

With this configuration, when the check information read by the check reading unit 11 contains unreadable information, the post-processing determining unit 20c determines to store check in the separate storing unit 15b.

When determining to store the check in the separate storing unit 15b, the post-processing determining unit 20c instructs the drive control unit 20d to drive the transport unit 14 in the transport direction so as to transport the check to the separate storing unit 15b. Accordingly, the check is transported to and stored in the separate storing unit 15b by the transport unit 14.

In this manner, when checks are stored by being sorted as checks for which the ex-post operation by the store staff is necessary and as checks for which the ex-post operation by the store staff is not necessary, efficiency of a check confirmation operation performed by the store staff can be improved. In other words, the store staff can perform the check confirmation operation without performing an operation of sorting checks for which confirmation is necessary and checks for which confirmation is not necessary from among checks stored in the storing unit 15.

The post-processing determining unit 20c may store checks whose check amounts are equal to or larger than a predetermined amount in the separate storing unit 15b, in addition to checks containing an unreadable item.

Furthermore, as shown in FIG. 7B, the storing unit 15 may include the separate storing unit 15a for stacking checks whose check amount is smaller than $100, the separate storing unit 15b for stacking checks whose check amounts are equal to or larger than $100 and smaller than $1000, and a separate storing unit 15c for stacking checks whose check amounts are equal to or larger than $1000.

With this configuration, when the check amount contained in the check information read by the check reading unit 11 is $500, the post-processing determining unit 20c determines to store the check in the separate storing unit 15b. Accordingly, similarly to the situation illustrated in FIG. 7A, the check is transported to and stored in the separate storing unit 15b by the transport unit 14.

In this manner, when checks are stored by being sorted according to the check amounts, it is possible to efficiently store and manage the checks. In other words, while checks are normally stored for a predetermined period to ensure the security of the transaction, it is desirable to store checks with large check amounts for a longer period. This is because a risk for handling a check is increased as a check amount is increased. Therefore, as shown in FIG. 7B, when checks are stored by being sorted according to check amounts, the checks can be sorted according to storage periods. As a result, it is possible to easily store and manage the checks.

Furthermore, as shown in FIG. 7C, the storing unit 15 may include the separate storing unit 15a for stacking checks issued by an A bank, the separate storing unit 15b for stacking checks issued by a B bank, and the separate storing unit 15c for stacking checks issued by a C bank.

With this configuration, when the check is identified to have been issued by the A bank based on a bank number contained in the check information read by the check reading unit 11, the post-processing determining unit 20c determines to store the check in the separate storing unit 15a.

When determining to store the check in the separate storing unit 15a, the post-processing determining unit 20c instructs the drive control unit 20d to drive the transport unit 14 in the transport direction so as to transport the check to the separate storing unit 15a. Accordingly, the check is transported to and stored in the separate storing unit 15a by the transport unit 14.

In this manner, when checks are stored by being sorted according to financial institutions that have issued the checks, it is possible to efficiently store and manage the checks. In other words, stores sometimes send an actual paper check received from the customer to a bank that has issued the check. In this case, because the checks are stored by being sorted according to the banks, it is possible to omit cumbersome operations of sorting the checks according to the hanks that have issued the checks. Therefore, it is possible to efficiently store and manage the checks.

As described above, when the storing unit 15 includes a plurality of separate storing units and the post-processing determining unit 20c determines, upon determining to store a check in the storing unit 15, in what separate storing unit the check is stored based on the check information read by the check reading unit 11, it is possible to efficiently perform the ex-post operation, and the checks can be stored and managed efficiently.

The separate storing units may be formed by dividing the single storing unit 15 by using partition plates and the like. It is also possible to use, as the separate storing units, a plurality of storing units each formed separately.

As described above, the check processing apparatus according to the present invention is useful for appropriately performing post processing of a check from which check information has been read. More specifically, the check processing apparatus according to the present invention is suitable for appropriately determining whether to store the check or to return the check.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A check handling machine comprising:
an inlet for receiving a check;
a transport path for transporting the check fed into the inlet;
a scanner for reading a check information including a check amount, from the check transported through the transport path;
one or a plurality of displays for displaying at least any one of information contained in the check image or the check information;
one or a plurality of operation units for receiving information inputted by a user;
one or a plurality of storage units for storing the check transported through the transport path; and
a controller for determining, after handling of the check has been completed, whether the check is stored in the storage unit or the check is ejected to the outside of the machine, based on the check information read by the scanner.

2. The check handling machine according to claim 1, wherein the display is provided such that both a customer using the check and a user operating the check handling machine are able to visually check a content displayed on the display.

3. The check handling machine according to claim 2, wherein the operation unit comprises an operation portion for the customer using the check, and an operation portion for the user operating the check handling machine.

4. The check handling machine according to claim 1, wherein the controller halts all the checks on the transport path after the checks have passed through the scanner, and restarts transporting the checks in the case a subsequent handling of the checks is determined.

5. The check handling machine according to claim 3, further comprising a window portion provided on a case body of the check handling machine such that at least a part of the check halted on the transport path is visible therethrough.

6. The check handling machine according to claim 1, wherein the controller determines the check is stored in the storage unit in the case the check amount is higher than a predetermined amount.

7. The check handling machine according to claim 1, wherein the controller. determines the check is stored the storage unit, the case an information to supplement check information the scanner is unable to read from the check, is inputted from the operation unit.

8. The check handling machine according to claim wherein the storage unit is provided in a plural number, and the controller sorts and stacks the check into the plurality of storage units respectively, based on the check information read by the scanner, in the case the check is determined to be stored in the storage unit.

9. The check handling machine according to claim 8, further comprising a printer for printing a predetermined information, including an information indicating the check has been handled, onto the check transported by the transport unit.
